(19) United States
(12) Patent Application Publication
(10) Pub. No.: US 2024/0071655 A1
(43) Pub. Date: Feb. 29, 2024

(54) TRANSIENT VOLTAGE PROTECTION DEVICE

(71) Applicant: TDK CORPORATION, Tokyo (JP)

(72) Inventors: Shunsuke TAKAHASHI, Tokyo (JP); Masato HAYATSU, Tokyo (JP); Sota HIRABA, Tokyo (JP); Naoyoshi YOSHIDA, Tokyo (JP)

(73) Assignee: TDK CORPORATION, Tokyo (JP)

(21) Appl. No.: 18/455,984

(22) Filed: Aug. 25, 2023

(30) Foreign Application Priority Data
Aug. 31, 2022 (JP) 2022-137739

(51) Int. Cl. H01C 1/148; H01C 7/12

(52) U.S. Cl. CPC H01C 1/148; H01C 7/12

(57) ABSTRACT

A transient voltage protection device includes an element body formed with a cavity inside, a pair of internal electrodes, and a discharge assistance portion. The pair of internal electrodes are disposed in the element body and include edges. The edges include parts opposing each other in a first direction in the cavity. The discharge assistance portion is in contact with the parts of the edges. Each of the edges includes a first end exposed on an outer surface of the element body and a second end located opposite the first end and including a corner. The discharge assistance portion includes a pair of edges opposing each other in a second direction intersecting with the first direction and exposed to the cavity. The part included in each of the edges does not include the corner.

### CROSS-REFERENCE TO RELATED APPLICATIONS

This application is based upon and claims the benefit of priority from Japanese Patent Application No. 2022-137739, filed on Aug. 31, 2022. The entire contents of which are incorporated herein by reference.

### BACKGROUND

### Field

The present disclosure relates to a transient voltage protection device.

### Description of the Related Art

Known transient voltage protection devices include an element body formed with a cavity inside, a pair of external electrodes disposed on the element body, and a pair of internal electrodes and a discharge assistance portion disposed in the element body (see, for example, PCT International Publication No. WO2009/098944). The pair of internal electrodes include edges. Parts of the edges oppose each other in the cavity. The discharge assistance portion is in contact with the parts included in the edges.

### SUMMARY

In a configuration in which a length of the discharge assistance portion is greater than a length of the cavity in a direction intersecting with a direction in which the parts included in the edges of the pair of internal electrodes opposing each other, the discharge assistance portion includes a region not exposed to the cavity between the parts of the edges opposing each other. In the present configuration, a discharge may be caused in the region of the discharge assistance portion exposed to the cavity and in a region of the discharge assistance portion not exposed to the cavity. Since the discharge between the regions not exposed to the cavity does not occur through the cavity, a clamp voltage may be affected by an electric resistance value of the element body. In this case, the clamp voltage may vary.

An object of each aspect of the present disclosure is to provide a transient voltage protection device that reduces a variation in the clamp voltage.

A transient voltage protection device according to one aspect of the present disclosure includes an element body formed with a cavity inside, a pair of external electrodes disposed on the element body, a pair of internal electrodes, and a discharge assistance portion. The pair of internal electrodes are disposed in the element body and include edges. The edges include parts opposing each other in a first direction in the cavity. The discharge assistance portion is disposed in the element body and is in contact with the parts included in the edges. Each of the edges includes a first end and a second end. The first end is exposed on an outer surface of the element body and is connected to a corresponding external electrode of the pair of external electrodes. The second end is located opposite the first end and includes a corner. The discharge assistance portion includes a pair of edges opposing each other in a second direction intersecting with the first direction and exposed to the cavity. The part included in each of the edges does not include the corner.

In the one aspect described above, the discharge assistance portion includes the pair of edges opposing each other in the second direction and exposed to the cavity. Therefore, the length of the discharge assistance portion is shorter than the length of the cavity in the second direction. Between the parts included the edges opposing each other, the discharge assistance portion does not include the region not exposed to the cavity. As a result, the one aspect described above tends not to causes the discharge not through the cavity.

The parts included in the edges oppose each other in the cavity and do not include the corner included in the second end. Therefore, the corner is not exposed to the cavity and is not in contact with the discharge assistance portion. As a result, the one aspect described above reliably causes a discharge in the region of the discharge assistance portion exposed to the cavity. Hereinafter, the region of the discharge assistance portion exposed to the cavity may be simply referred to as an “exposed region”.

As described above, the one aspect described above reduces the variation in the clamp voltage.

In the one aspect described above, the discharge assistance portion may include another pair of edges opposing each other in the first direction and in contact with corresponding internal electrode of the pair of internal electrodes.

A configuration in which the discharge assistance portion includes another pair of edges further reliably causes the discharge in the exposed region. Therefore, the present configuration further reduces the variation in the clamp voltage.

In the one aspect described above, the discharge assistance portion may be curved in a cross section along a third direction intersecting with the first direction and the second direction.

A configuration in which the discharge assistance portion is curved as described above tends to increase a facing area of the pair of internal electrodes. Therefore, the present configuration can reduce a deterioration of a transient voltage protection characteristics.

In the one aspect described above, the pair of internal electrodes may be curved in the cross section.

A configuration in which the pair of internal electrodes are curved as described above tends to increase the facing area of the pair of internal electrodes. Therefore, the present configuration can reduce the deterioration of the transient voltage protection characteristics.

In the one aspect described above, the pair of internal electrodes may be curved along the discharge assistance portion in the cross section.

A configuration in which the pair of internal electrodes are curved along the discharge assistance portion in the cross section tends to further increase the facing area of the pair of internal electrodes. Therefore, the present configuration can further reduce the deterioration of the transient voltage protection characteristics.

In the one aspect described above, between the parts included in the edges, the discharge assistance portion may include a length in the second direction longer than an interval in the second direction between each of the pair of edges of the discharge assistance portion and a corresponding end of both ends of the cavity.

A configuration in which the discharge assistance portion includes the length in the second direction longer than the interval further reliably causes the discharge in the exposed region. Therefore, the present configuration further reduces the variation in the clamp voltage.

A transient voltage protection device according to another aspect of the present disclosure includes an element body formed with a cavity inside, a pair of external electrodes disposed on the element body, a pair of internal electrodes disposed in the element body to oppose each other in a first direction and exposed to the cavity, and a discharge assistance portion disposed in the element body. The discharge assistance portion is in contact with the pair of internal electrodes. Each of the pair of internal electrodes includes a first end and a second end. The first end is connected to a corresponding external electrode of the pair of external electrodes. The second end is located opposite the first end and includes a corner. The discharge assistance portion includes a pair of edges opposing each other in a second direction intersecting with the first direction. The pair of edges are located inside the cavity when viewed in a third direction intersecting with the first direction and the second direction. The corner is not exposed to the cavity and is not in contact with the discharge assistance portion.

In another aspect described above, the pair of edges of the discharge assistance portion are located inside the cavity when viewed in the third direction. Therefore, a length of the discharge assistance portion is shorter than a length of the cavity in the second direction. Between the pair of internal electrodes opposing each other, the discharge assistance portion does not include a region not exposed to the cavity. As a result, another aspect described above tends not to cause a discharge not through the cavity.

The corner included in the second end is not exposed to the cavity and is not in contact with the discharge assistance portion. Therefore, another aspect described above reliably causes a discharge in a region of the discharge assistance portion exposed to the cavity.

As described above, another aspect described above reduces the variation in the clamp voltage.

The present disclosure will become more fully understood from the detailed description given hereinafter and the accompanying drawings which are given by way of illustration only, and thus are not to be considered as limiting the present disclosure.

Further scope of applicability of the present disclosure will become apparent from the detailed description given hereinafter. However, it should be understood that the detailed description and specific examples, while indicating embodiments of the present disclosure, are given by way of illustration only, since various changes and modifications within the spirit and scope of the present disclosure will become apparent to those skilled in the art from this detailed description.

### BRIEF DESCRIPTION OF THE DRAWINGS

FIG. 1 is a perspective view illustrating a transient voltage protection device according to an embodiment;

FIG. 2 is an exploded perspective view illustrating a configuration of an element body;

FIG. 3 is a view illustrating a pair of internal electrodes and a discharge assistance portion;

FIG. 4 is a view illustrating a cross-sectional configuration along line IV-IV of FIG. 1; and

FIG. 5 is a view illustrating a cross-sectional configuration along line V-V in FIG. 1.

### DETAILED DESCRIPTION

Hereinafter, embodiments of the present disclosure will be described in detail with reference to the accompanying drawings. In the following description, the same elements or elements having the same functions are denoted with the same reference numerals and overlapped explanation is omitted.

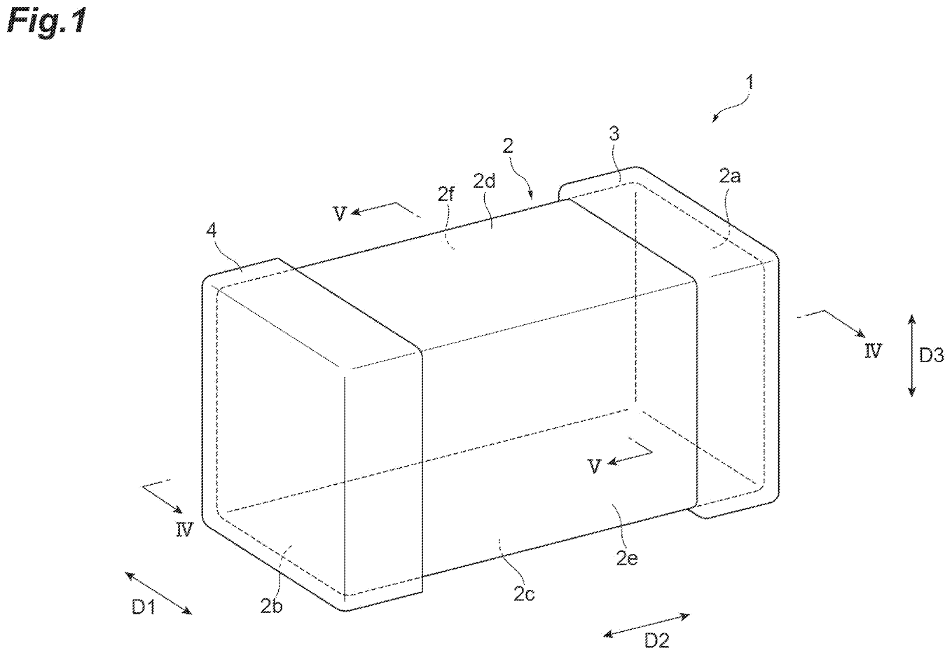

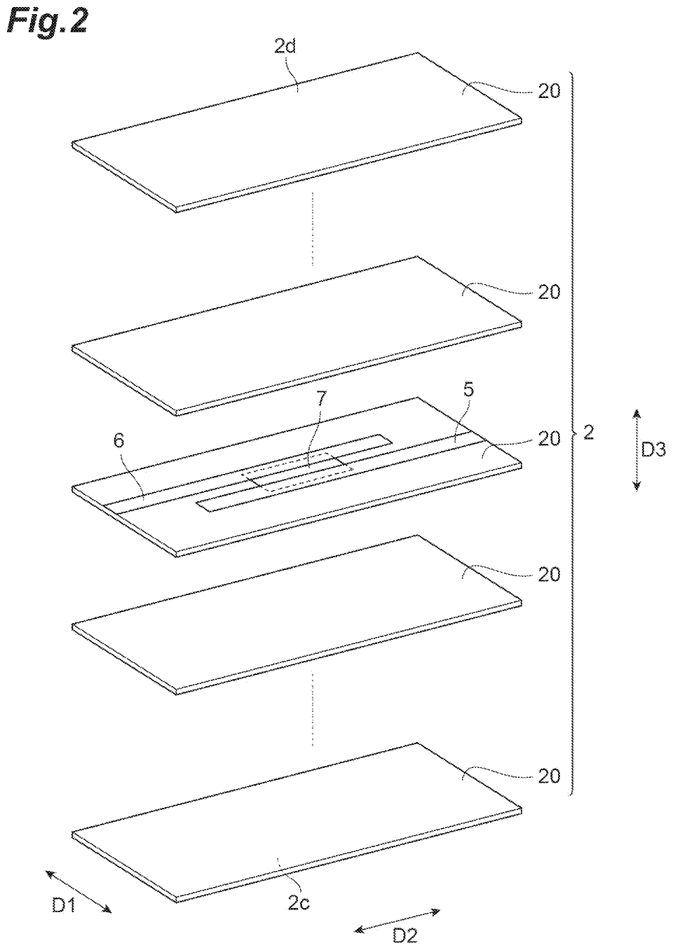

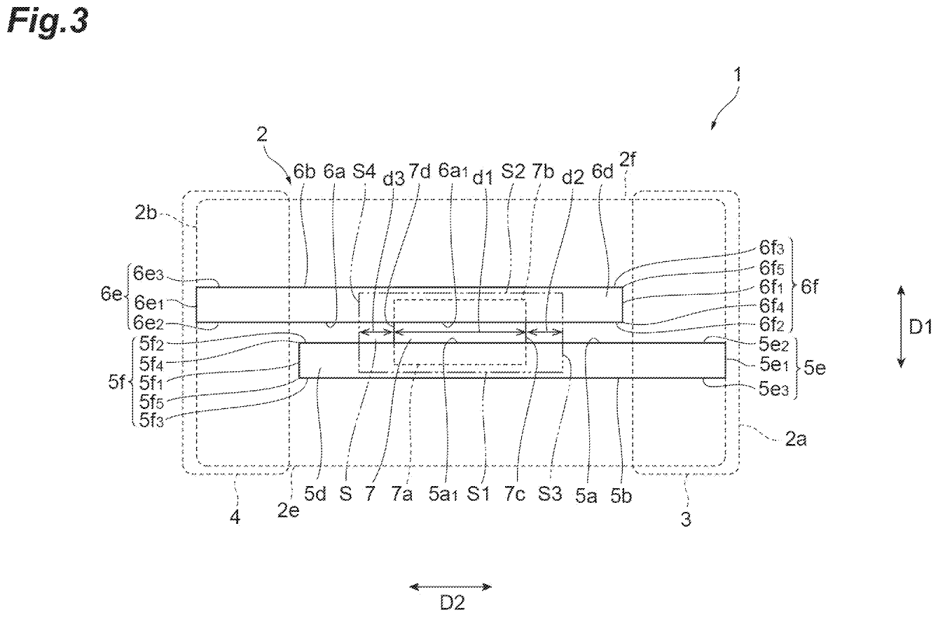

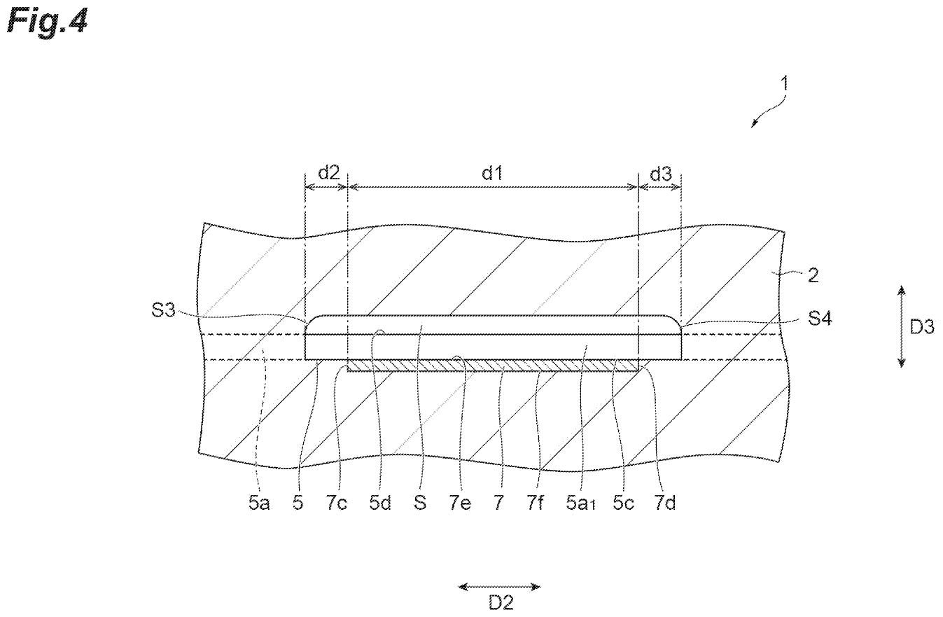

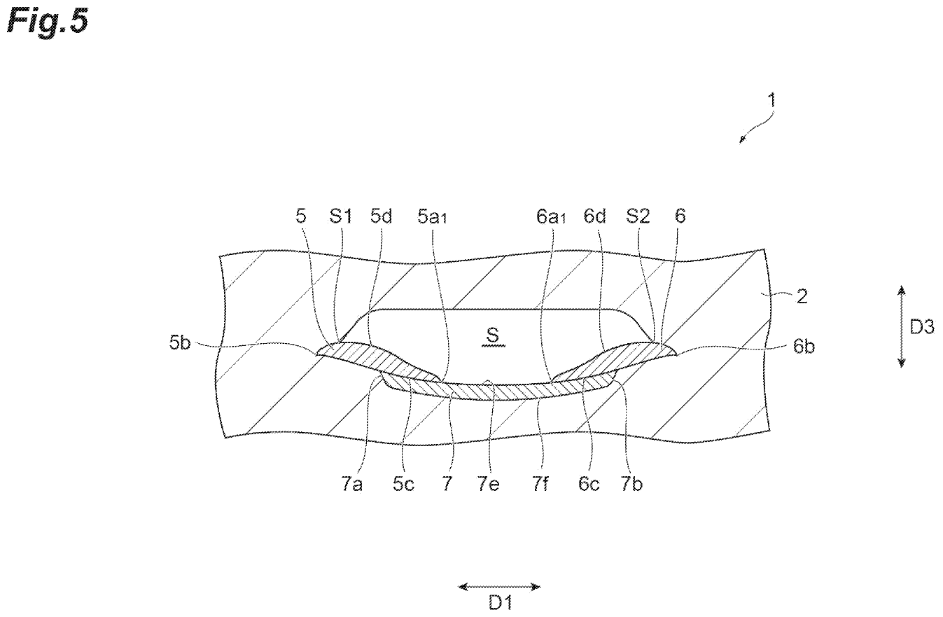

A configuration of a transient voltage protection device 1 according to the present embodiment will be described with reference to FIGS. 1 to 5. FIG. 1 is a perspective view illustrating the transient voltage protection device according to the present embodiment. FIG. 2 is an exploded perspective view illustrating a configuration of an element body. FIG. 3 is a view illustrating a pair of internal electrodes and a discharge assistance portion. FIG. 4 is a view illustrating a cross-sectional configuration along line IV-IV of FIG. 1. FIG. 5 is a view illustrating a cross-sectional configuration along line V-V in FIG. 1.

As illustrated in FIGS. 1 and 2, the transient voltage protection device 1 includes an element body 2, a pair of external electrodes 3 and 4, a pair of internal electrodes 5 and 6, and a discharge assistance portion 7. The transient voltage protection device 1 is mounted in an electronic device (not illustrated). The transient voltage protection device 1 protects the electronic device from a transient voltage. The electronic device protected by the transient voltage protection device 1 includes, for example, a circuit board or an electronic component. The transient voltage is caused by, for example, electro-static discharge (ESD).

The element body 2 has a rectangular parallelepiped shape. The rectangular parallelepiped shape includes, for example, a shape of a rectangular parallelepiped in which corner portions and ridgeline portions are chamfered or a shape of a rectangular parallelepiped in which corner portions and ridgeline portions are rounded. The element body 2 includes a pair of end surfaces 2a and 2b opposing each other, a pair of side surfaces 2c and 2d opposing each other, and a pair of side surfaces 2e and 2f opposing each other. In the present embodiment, the pair of side surfaces 2e and 2f oppose each other in a first direction D1. The pair of end surfaces 2a and 2b oppose each other in a second direction D2. The pair of side surfaces 2c and 2d oppose each other in a third direction D3. An outer surface of the element body 2 includes the pair of end surfaces 2a and 2b and the four side surfaces 2c, 2d, 2e, and 2f. The four side surfaces 2c, 2d, 2e, and 2f are adjacent to the end surface 2a and the end surface 2b and extend in the second direction D2 to couple the end surface 2a and the end surface 2b to each other. One side surface of the four side surfaces 2c, 2d, 2e, and 2f is defined as a mounting surface opposing the electronic device on which the transient voltage protection device 1 is mounted.

As illustrated in FIG. 2, the element body 2 is formed through laminating a plurality of insulator layers 20 in the third direction D3. The element body 2 includes the plurality of laminated insulator layers 20. In the element body 2, the insulator layers 20 are integrated with each other to such an extent that each boundary between the insulator layers 20 cannot be visually recognized. Each insulator layer 20 is formed as, for example, a sintered body of a ceramic green sheet. The ceramic green sheet includes an insulator material.

The insulator material is an electrically insulator material. The insulator material includes, for example, a ceramic material. The ceramic material is selected from the group consisting of Fe₂O₃, NiO, CuO, ZnO, MgO, SiO₂, TiO₂, MnCO₃, SrCO₃, CaCO₃, BaCO₃, Al₂O₃, ZrO₂, and B₂O₃, for example. The insulator layer 20 may include only a single ceramic material, or may include two or more kinds of ceramic materials. The insulator layer 20 may include glass. The insulator layer 20 may include copper oxide to enable low temperature sintering. The copper oxide includes CuO or Cu₂O.

The first direction D1 is a width direction of the element body 2. The second direction D2 is a length direction of the element body 2. The third direction D3 is a height direction of the element body 2. The width of the element body 2 is, for example, 0.3 mm or more and 1.2 mm or less. The length of the element body 2 is, for example, 0.6 mm or more and 2.0 mm or less. The height of the element body 2 is, for example, 0.2 mm or more and 1.2 mm or less. In the present embodiment, the width of the element body 2 is 1.0 mm, the length of the element body 2 is 0.5 mm, and the height of the element body 2 is 0.5 mm.

The external electrodes 3 and 4 are disposed on the element body 2. The external electrodes 3 and 4 are disposed on the element body 2 to oppose each other in the second direction D2. The external electrodes 3 and 4 are disposed at both end portions of the element body 2 in the second direction D2. The external electrodes 3 and 4 are separated from each other in the second direction D2.

The external electrode 3 is disposed on the end surface 2a. The external electrode 3 is connected to the internal electrode 5. The external electrode 3 is physically and electrically connected to the internal electrode 5. The external electrode 3 covers the end surface 2a. The external electrode 3 also covers a part of each of the four side surfaces 2c, 2d, 2e, and 2f. The part of each of the four side surfaces 2c, 2d, 2e, and 2f covered with the external electrode 3 is located near the end surface 2a in the corresponding side surface of the four side surfaces 2c, 2d, 2e, and 2f. The external electrode 3 is disposed on the entire surface of the end surface 2a and the end portions of the side surfaces 2c, 2d, 2e, and 2f near the end surface 2a.

The external electrode 4 is disposed on the end surface 2b. The external electrode 4 is connected to the internal electrode 6. The external electrode 4 is physically and electrically coupled to the internal electrode 6. The external electrode 4 covers the end surface 2b. The external electrode 4 also covers a part of each of the four side surfaces 2c, 2d, 2e, and 2f. The part of each of the four side surfaces 2c, 2d, 2e, and 2f covered with the external electrode 4 is located near the end surface 2b in the corresponding side surface of the four side surfaces 2c, 2d, 2e, and 2f.

The external electrode 4 is disposed on the entire surface of the end surface 2b and the end portions of the side surfaces 2c, 2d, 2e, and 2f near the end surface 2b.

The internal electrode 5 and 6 are disposed in the element body 2 to oppose each other in the first direction D1. Each of the internal electrodes 5 and 6 extends in the second direction D2. The internal electrode 5 is disposed near the side surface 2e. The internal electrode 6 is disposed near the side surface 2f. The internal electrodes 5 and 6 are disposed at the same height position, that is, at the same laminating position in the third direction D3. As illustrated in FIG. 2, the internal electrodes 5 and 6 are disposed on the same insulator layer 20. The internal electrodes 5 and 6 are disposed substantially in the center in the third direction D3, that is, in the laminating direction of the insulator layers 20.

As illustrated in FIG. 3, the internal electrode 5 includes a pair of edges 5a and 5b opposing each other and a pair of surfaces 5c and 5d opposing each other. The pair of edges 5a and 5b oppose each other in the first direction D1. The pair of surfaces 5c and 5d oppose each other in the third direction D3. In the present embodiment, the edge 5a includes a pair of ends 5e and 5f. The internal electrode 5 includes the pair of ends 5e and 5f in addition to the pair of edges 5a and 5b and the pair of surfaces 5c and 5d. The edge 5a opposes the internal electrode 6. Each of the edges 5a and 5b is adjacent to the surface 5c and the surface 5d.

The end 5e is exposed on the outer surface of the element body 2. The end 5e is exposed on the end surface 2a. The end 5e is coupled to the external electrode 3. In the present embodiment, the end 5e is directly coupled to the external electrode 3. The end 5e includes an end coupled to the external electrode 3. The end 5e includes an end of the internal electrode 5 and a region extending from the end of the internal electrode 5 to a predetermined length. Therefore, the end 5e has the predetermined length in the second direction D2.

In the present embodiment, the end 5e includes a surface 5e₁, a portion 5e₂, and a portion 5e₃. The surface 5e₁ is exposed on the end surface 2a. The portion 5e₂ is located near the internal electrode 6 and extends in the second direction D2. The portion 5e₃ is located opposite the portion 5e₂ and extends in the second direction D2. The edge 5a includes the portion 5e₂ of the end 5e. The end 5e includes a portion included in the edge 5a and a portion not included in the edge 5a.

The end 5f is located opposite the end 5e in the second direction D2. The end 5f is located inside the element body 2 and is not exposed on the outer surface of the element body 2. The end 5f is separated from each of the end surfaces 2a and 2b. The end 5f is buried in the element body 2 and is in contact with the element body 2 only. The end 5f is separated from the external electrode 4 and does not overlap the external electrode 4 when viewed in the third direction D3. Similarly to the end 5e, the end 5f also includes a region extending from an end of the internal electrode 5 to a predetermined length. Therefore, the end 5f also has the predetermined length in the second direction D2.

In the present embodiment, the end 5f includes a surface 5f₁, a portion 5f₂, a portion 5f₃, and corners 5f₄ and 5f₅. The surface 5f₁ includes an end surface of the internal electrode 5. The portion 5f₂ is located near the internal electrode 6 and extends in the second direction D2. The portion 5f₃ is located opposite the portion 5f₂ and extends in the second direction D2. The corner 5f4 is located between the surface 5f₁ and the portion 5f₂. The surface 5f₁ and the portion 5f₂ are adjacent to the corner 5f₄. The corner 5f₅ is located between the surface 5f₁ and the portion 5f₃. The surface 5f₁ and the portion 5f₃ are adjacent to the corner 5f₅. The edge 5a includes the portion 5f2 of the end 5f. The end 5f includes a portion included in the edge 5a and a portion not included in the edge 5a. For example, when the end 5e includes a first end, the end 5f includes a second end.

As illustrated in FIG. 3, the internal electrode 6 includes a pair of edges 6a and 6b opposing each other and a pair of surfaces 6c and 6d opposing to each other. The pair of edges 6a and 6b are opposing to each other in the first direction D1. The pair of surfaces 6c and 6d oppose each other in the third direction D3. In the present embodiment, the edge 6a includes a pair of ends 6e and 6f. The internal electrode 6 includes the pair of ends 6e and 6f in addition to the pair of edges 6a and 6b and the pair of surfaces 6c and 6d. The edge 6a opposes the internal electrode 5. Each of the edges 6a and 6b is adjacent to the surface 6c and the surface 6d.

The end 6e is exposed on the outer surface of the element body 2. The end 6e is exposed on the end surface 2b. The end 6e is coupled to the external electrode 4. In the present embodiment, the end 6e is directly coupled to the external electrode 4. The end 6e includes an end coupled to the external electrode 4. The end 6e includes an end of the internal electrode 6 and a region extending from the end of the internal electrode 6 to a predetermined length. Therefore, the end 6e has the predetermined length in the second direction D2.

In the present embodiment, the end 6e includes a surface 6e₁, a portion 6e₂, and a portion 6e₃. The surface 6e₁ is exposed on the end surface 2b. The portion 6e₂ is located near the internal electrode 5 and extends in the second direction D2. The portion 6e₃ is located opposite the portion 6e₂ and extends in the second direction D2. The edge 6a includes the portion 6e₂ of the end 6e. The end 6e includes a portion included in the edge 6a and a portion not included in the edge 6a.

The end 6f is located opposite the end 6e in the second direction D2. The end 6f is located inside the element body 2 and is not exposed on the outer surface of the element body 2. The end 6f is separated from each of the end surfaces 2a and 2b. The end 6f is buried in the element body 2 and is in contact with the element body 2 only. The end 6f is separated from the external electrode 3 and does not overlap the external electrode 3 when viewed in the third direction D3. Similarly to the end 6e, the end 6f also includes a region extending from an end of the internal electrode 6 to a predetermined length. Therefore, the end 6f also has the predetermined length in the second direction D2.

In the present embodiment, the end 6f includes a surface 6f₁, a portion 6f₂, a portion 6f₃, and corners 6f₄ and 6f₅. The surface 6f₁ includes an end surface of the internal electrode 6. The portion 6f₂ is located near the internal electrode 5 and extends in the second direction D2. The portion 6f₃ is located opposite the portion 6f₂ and extends in the second direction D2. The corner 6f₄ is located between the surface 6f₁ and the portion 6f₂. The surface 6f₁ and the portion 6f₂ are adjacent to the corner 6f₄. The corner 6f₅ is located between the surface 6f₁ and the portion 6f₃. The surface 6f₁ and the portion 6f₃ are adjacent to the corner 6f₅. The edge 6a includes the portion 6f2 of the edge 6f. The end 6f includes a portion included in the edge 6a and a portion not included in the edge 6a. For example, when the end 6e includes a first end, the end 6f includes a second end.

The external electrodes 3 and 4 and internal electrodes 5 and 6 include electrically a conductive material. The conductive material includes, for example, Ag, Pd, Au, Pt, Cu, Ni, Al, Mo, or W. The conductive material may include, for example, a Ag/Pd alloy, a Ag/Cu alloy, a Ag/Au alloy, or a Ag/Pt alloy. The external electrodes 3 and 4 and internal electrodes 5 and 6 may include the same electrically conductive material. The external electrodes 3 and 4 and internal electrodes 5 and 6 may include electrically conductive materials different from each other.

The external electrodes 3 and 4 are formed, for example, through sintering an electrically conductive paste applied to the outer surface of the element body 2. The electrically conductive paste for forming the external electrodes 3 and 4 includes the above electrically conductive material. The internal electrodes 5 and 6 are formed, for example, through firing the electrically conductive paste applied on an insulator green sheet together with the insulator green sheet. The electrically conductive paste is applied on the insulator green sheet, for example, through printing. The electrically conductive paste for forming the internal electrodes 5 and 6 also includes the above electrically conductive material.

As illustrated in FIGS. 2 to 5, the discharge assistance portion 7 is disposed in the element body 2. The discharge assistance portion 7 is separated from the outer surface of the element body 2. The discharge assistance portion 7 is not exposed from the element body 2. The discharge assistance portion 7 includes a pair of edges 7a and 7b opposing each other and a pair of edges 7c and 7d opposing each other. The pair of edges 7a and 7b oppose each other in the first direction D1. The pair of edges 7c and 7d oppose each other in the second direction D2. The discharge assistance portion 7 has a rectangular shape defined by four edges 7a, 7b, 7c, and 7d when viewed in the third direction D3. The rectangular shape includes a shape with corners rounded or a shape with corners removed. The discharge assistance portion 7 is separated from the outer surface of the element body 2. The discharge assistance portion 7 is not exposed from the element body 2.

The discharge assistance portion 7 further includes a pair of surfaces 7e and 7f opposing each other. The pair of surfaces 7e and 7f oppose each other in the third direction D3. The surface 7e is in contact with the internal electrodes 5 and 6. The surface 7e is in contact with the surface 5c of the internal electrode 5 and the surface 6c of the internal electrode 6. The internal electrodes 5 and 6 are disposed on the surface 7e. The surface 7e includes a region covered with the internal electrodes 5 and 6 and a region exposed from the internal electrodes 5 and 6. The surface 7f is in contact with the element body 2. The entire surface 7f is covered with the element body 2. The discharge assistance portion 7 is in contact with the internal electrodes 5 and 6 and couples the internal electrodes 5 and 6. The internal electrode 5 and the internal electrode 6 are coupled via the discharge assistance portion 7. A transient voltage suppressor includes the discharge assistance portion 7 and the internal electrodes 5 and 6. The transient voltage suppressor has transient voltage absorption capability.

A width of the discharge assistance portion 7 is, for example, 0.03 mm or more and 0.9 mm or less. A length of the discharge assistance portion 7 is, for example, 0.03 mm or more and 1.6 mm or less. A thickness of discharge assistance portion 7 is, for example, 0.5 μm or more and 10 μm or less. In the present embodiment, the width of the discharge assistance portion 7 is 0.2 mm, the length of the discharge assistance portion 7 is 0.3 mm, and the thickness of the discharge assistance portion 7 is 2 μm. The width of the discharge assistance portion 7 is defined by, for example, the length in the first direction D1. The length of the discharge assistance portion 7 is defined by, for example, the length in the second direction D2. The thickness of the discharge assistance portion 7 is defined by, for example, the length in the third direction D3.

The discharge assistance portion 7 includes an insulator and a metal particle. The insulator is an electrically insulator. The insulator includes, for example, a ceramic material. The ceramic material is selected from the group consisting of Fe₂O₃, NiO, CuO, ZnO, MgO, SiO₂, TiO₂, MnCO₃, SrCO₃, CaCO₃, BaCO₃, Al₂O₃, ZrO₂, and B₂O₃, for example. The discharge assistance portion 7 may include only one type of ceramic material selected from this group, or may include two or more types of ceramic materials selected from this group. The metal particle includes, for example, Ag, Pd, Au, Pt, a Ag/Pd alloy, a Ag/Cu alloy, a Ag/Au alloy, or a Ag/Pt alloy. The discharge assistance portion 7 may include a semiconductor particle. The semiconductor particle includes, for example, RuO₂. The discharge assistance portion 7 may include a glass.

The discharge assistance portion 7 is formed, for example, through firing slurry applied on the insulator green sheet together with the insulator green sheet. The slurry includes the ceramic material and the metal particle. The slurry is applied on the insulator green sheet, for example, through printing.

As illustrated in FIGS. 3 to 5, the element body 2 is formed with a cavity S inside. The cavity S is separated from the outer surface of the element body 2. Surfaces defining the cavity S include an inner surface of the element body 2, the edge 5a of the internal electrode 5, the surface 5d of the internal electrode 5, the edge 6a of the internal electrode 6, and the surface 6d of the internal electrode 6. The surfaces defining the cavity S also include the region of the discharge assistance portion 7 exposed from the internal electrodes 5 and 6. The region of the discharge assistance portion 7 exposed from the internal electrodes 5 and 6 is a region exposed to the cavity S. The discharge assistance portion 7 includes the region exposed to the cavity S.

An end S1 of the cavity S in the first direction D1 is located inside the edge 5b of the internal electrode 5 when viewed in the third direction D3. An end S2 of the cavity S in the first direction D1 is located inside the edge 6b of the internal electrode 6 when viewed in the third direction D3. An end S3 of the cavity S in the second direction D2 is located inside the end 6f of the internal electrode 6 when viewed in the third direction D3. An end S4 of the cavity S in the second direction D2 is located inside the end 5f of the internal electrode 5 when viewed in the third direction D3.

The cavity S is formed, for example, through firing an organic lacquer applied on the insulator green sheet together with the insulator green sheet. The cavity S is formed through burning out the organic lacquer. The organic lacquer includes an organic solvent and an organic binder. The organic lacquer is applied on the insulator green sheet, for example, through printing.

As illustrated in FIGS. 3 to 5, the edge 5a of the internal electrode and the edge 6a of the internal electrode 6 are exposed to the cavity S. In the present embodiment, a part 5a₁ of the edge 5a and a part 6a₁ of the edge 6a are exposed to the cavity S. The part 5a₁ and the part 6a₁ oppose each other in the cavity S. The part 5a₁ and the part 6a₁ oppose each other in the first direction D1. The part 5a₁ and the part 6a₁ are in contact with the discharge assistance portion 7. The discharge assistance portion 7 is disposed in the element body 2. The discharge assistance portion 7 is in contact with the part 5a₁ and the part 6a₁. The part 5a₁ and the part 6a₁ include a portion in contact with the discharge assistance portion 7 and a portion not in contact with the discharge assistance portion 7.

As described above, since the end S4 of the cavity S is located inside the end 5f of the internal electrode 5, the part 5a₁ exposed to the cavity S does not include the end 5f and the corners 5f₄ and 5f₅ included in the end 5f. Similarly, since the end S3 of the cavity S is located inside the end 6f of the internal electrode 6, the part 6a₁ exposed to the cavity S does not include the end 6f and the corners 6f4 and 6f₅ included in the end 6f. Therefore, the corners 5f₄ and 5f₅ and the corners 6f₄ and 6f₅ are not exposed to the cavity S.

As illustrated in FIG. 3, the pair of edges 7a and 7b of the discharge assistance portion 7 are located inside the cavity S when viewed in the third direction D3. In the present embodiment, when viewed in the third direction D3, the edge 7a is located inside the end S1, and the edge 7b is located inside the end S2. As described above, when viewed in the third direction D3, the end S1 is located inside the edge 5b of the internal electrode 5, and the end S2 is located inside the edge 6b of the internal electrode 6. Therefore, when viewed in the third direction D3, the edge 7a is located inside the edge 5b, and the edge 7b is located inside the edge 6b. The edge 7a is in contact with the internal electrode 5. The edge 7a is located inside a peripheral edge of the internal electrode 5. The edge 7b is in contact with the internal electrode 6. The edge 7b is located inside a peripheral edge of the internal electrode 6. The peripheral edge of the internal electrode 5 is defined by the edges 5a and 5b and the surfaces 5e₁ and 5f₁. The peripheral edge of the internal electrode 6 is defined by the edges 6a and 6b and the surfaces 6e₁ and 6f₁.

The pair of edges 7c and 7d of the discharge assistance portion 7 are exposed to the cavity S. In the present embodiment, parts of the pair of edges 7c and 7d are exposed to the cavity S. The pair of edges 7c and 7d include a portion exposed to the cavity S and a portion not exposed to the cavity S. The portions of the pair of edges 7c and 7d which are not exposed to the cavity S are in contact with the internal electrodes 5 and 6.

When viewed in the third direction D3, the pair of edges 7c and 7d of the discharge assistance portion 7 are also located inside the cavity S. In the present embodiment, when viewed in the third direction D3, the edge 7c is located inside the end S3, and the edge 7d is located inside the end S4. As described above, when viewed in the third direction D3, the end S3 is located inside the end 6f of the internal electrode 6, and the end S4 is located inside the end 5f of the internal electrode 5. Therefore, when viewed in the third direction D3, the edge 7c is located inside the end 6f, and the edge 7d is located inside the end 5f. The end 5f and the end 6f are not in contact with the discharge assistance portion 7. The corners 5f₄ and 5f₅ included in the end 5f are not in contact with the discharge assistance portion 7. The corners 6f4 and 6f₅ included in the edge 6f are not in contact with the discharge assistance portion 7.

As illustrated in FIGS. 3 and 4, between the part 5a₁ included in the edge 5a of the internal electrode 5 and the part 6a₁ included in the edge 6a of the internal electrode 6, a length d1 of the discharge assistance portion 7 in the second direction D2 is longer than an interval d2 in the second direction D2 between the edge 7c of the discharge assistance portion 7 and the end S3 of the cavity S and an interval d3 in the second direction D2 between the edge 7d of the discharge assistance portion 7 and the end S4 of the cavity S. That is, between the part 5a₁ included in the edge 5a of the internal electrode 5 and the part 6a₁ included in the edge 6a of the internal electrode 6, the discharge assistance portion 7 has the length d1 longer than the interval d2 and the interval d3. As described above, the length of the discharge assistance portion 7 is defined by the length d1 of the discharge assistance portion 7 in the second direction D2. Therefore, the length of the discharge assistance portion 7 is longer than the interval d2 and the interval d3. The interval d2 and the interval d3 may be the same or different.

FIG. 4 is a view of a cross section obtained through cutting the element body 2 along a plane orthogonal to the second direction D2 at a position where the cavity S is formed in a direction from the internal electrode 6 toward the internal electrode 5 in the first direction D1. In the present embodiment, even in a case where the cross section is viewed in a direction from the internal electrode 5 toward the internal electrode 6 in the first direction D1, between the part 5a₁ and the part 6a₁, a relationship between the length d1, the interval d2, and the interval d3 is the same as the relationship described above.

The length d1 being the length of discharge assistance portion 7 is, for example, 0.03 mm or more and 1.6 mm or less, as described above. The interval d2 is, for example, 0 mm or more and 0.6 mm or less. The interval d3 is, for example, 0 mm or more and 0.6 mm or less. In the present embodiment, the length d1 is 0.3 mm, the interval d2 is 0.1 mm, and the interval d3 is 0.1 mm.

As illustrated in FIG. 5, the discharge assistance portion 7 is curved in a cross section along the third direction D3. The cross section along the third direction D3 illustrated in FIG. 5 is a cross section obtained through cutting the element body 2 along a plane orthogonal to the first direction D1 at a position where the cavity S is formed. The discharge assistance portion 7 is curved in an arc shape in the cross section along the third direction D3. The surface 7e and the surface 7f are curved in an arc shape. The internal electrodes 5 and 6 are also curved in the cross section along the third direction D3. The internal electrodes 5 and 6 are curved along the discharge assistance portion 7 in the cross section along the third direction D3. In the present embodiment, a part of the surface 5c of the internal electrode 5 and a part of the surface 6c of the internal electrode 6 are curved along the surface 7e of the discharge assistance portion 7.

As described above, in the transient voltage protection device 1, the discharge assistance portion 7 includes the pair of edges 7c and 7d opposing each other in the second direction D2 and exposed to the cavity S. Therefore, the length of the discharge assistance portion 7 is shorter than the length of the cavity S in the second direction D2. Between the part 5a₁ included in the edge 5a and the part 6a₁ included in the edge 6a opposing each other, the discharge assistance portion 7 does not include a region not exposed to the cavity S. As a result, the transient voltage protection device 1 tends not to generate a discharge through the cavity S.

In the transient voltage protection device 1, the part 5a₁ of the edge 5a and the part 6a₁ of the edge 6a oppose each other in the cavity S, the part 5a₁ does not include the corners 5f₄ and 5f₅ of the edge 5f, and the part 6a₁ does not include the corners 6f₄ and 6f₅ of the end 6f. Therefore, the corners 5f₄ and 5f₅ and the corners 6f₄ and 6f₅ are not exposed to the cavity S and are not in contact with the discharge assistance portion 7. As a result, the transient voltage protection device 1 reliably causes a discharge in the region of the discharge assistance portion 7 exposed to the cavity S.

As described above, the transient voltage protection device 1 reduces a variation in a clamp voltage.

In the transient voltage protection device 1, the discharge assistance portion 7 includes the pair of edges 7a and 7b opposing each other in the first direction D1. The edge 7a is in contact with the internal electrode 5. The edge 7b is in contact with the internal electrode 6.

The transient voltage protection device 1 further reliably causes the discharge in the region of the discharge assistance portion 7 exposed to the cavity S. Therefore, the transient voltage protection device 1 further reduces the variation in the clamp voltage.

In the transient voltage protection device 1, the discharge assistance portion 7 is curved in the cross section along the third direction D3.

The transient voltage protection device 1 tends to increase a facing area of the pair of internal electrodes 5 and 6. Therefore, the transient voltage protection device 1 can reduce a deterioration of a transient voltage protection characteristics.

In the transient voltage protection device 1, the pair of internal electrodes 5 and 6 are curved in the cross section along the third direction D3.

The transient voltage protection device 1 tends to increase the facing area of the pair of internal electrodes 5 and 6. Therefore, the transient voltage protection device 1 can reduce the deterioration of the transient voltage protection characteristics.

In the transient voltage protection device 1, the pair of internal electrodes 5 and 6 are curved along the discharge assistance portion 7 in the cross section along the third direction D3.

The transient voltage protection device 1 tends to further increase the facing area of the pair of internal electrodes 5 and 6. Therefore, the transient voltage protection device 1 can further reduce the deterioration of the transient voltage protection characteristics.

In the transient voltage protection device 1, between the part 5a₁ included in the edge 5a of the internal electrode 5 and the part 6a₁ included in the edge 6a of the internal electrode 6, the discharge assistance portion 7 includes the length d1 in the second direction D2 longer than the interval d2 in the second direction D2 between the edge 7c of the discharge assistance portion 7 and the end S3 of the cavity S and the interval d3 in the second direction D2 between the edge 7d of the discharge assistance portion 7 and the end S4 of the cavity S.

The transient voltage protection device 1 further reliably causes the discharge in the region of the discharge assistance portion 7 exposed to the cavity S. Therefore, the transient voltage protection device 1 further reduce the variation in the clamp voltage.

In the transient voltage protection device 1, the pair of edges 7c and 7d of the discharge assistance portion 7 are located inside the cavity S when viewed in the third direction D3. Therefore, the length of the discharge assistance portion 7 is shorter than the length of the cavity S in the second direction D2. Between the pair of internal electrodes 5 and 6 opposing each other, the discharge assistance portion 7 does not include the region not exposed to the cavity S. As a result, the transient voltage protection device 1 tends not to cause a discharge not through the cavity S.

In the transient voltage protection device 1, the corners 5f₄ and 5f₅ and the corners 6f₄ and 6f₅ are not exposed to the cavity S and are not in contact with the discharge assistance portion 7. Therefore, the transient voltage protection device 1 reliably causes the discharge in the region of the discharge assistance portion 7 exposed to the cavity S.

As described above, the transient voltage protection device 1 reduces the variation in the clamp voltage.

Although the embodiment of the present disclosure has been described above, the present disclosure is not necessarily limited to the embodiment, and the embodiment can be variously changed without departing from the scope of the disclosure.

The edge 7a may not be in contact with the internal electrode 5, and the edge 7b may not be in contact with the internal electrode 6. In this case, the edge 7a may be located outside the edge 5b of the internal electrode 5 in the first direction D1, and the edge 7b may be located outside the edge 6b of the internal electrode 6 in the first direction D1. The transient voltage protection device 1 in which the edge 7a is in contact with the internal electrode 5 and the edge 7b is in contact with the internal electrode 6 further reduces the variation in the clamp voltage as described above.

The discharge assistance portion 7 may not be curved in the cross section along the third direction D3. The transient voltage protection device 1 in which the discharge assistance portion 7 is curved in the cross section along the third direction D3 reduce the deterioration of the transient voltage protection characteristics as described above.

The pair of internal electrodes 5 and 6 may not be curved in the cross section along the third direction D3. The transient voltage protection device 1 in which the pair of internal electrodes 5 and 6 are curved in the cross section along the third direction D3 reduce the deterioration of the transient voltage protection characteristics as described above.

The pair of internal electrodes 5 and 6 may not be curved along the discharge assistance portion 7 in the cross section along the third direction D3. The transient voltage protection device 1 in which the pair of the internal electrodes 5 and 6 are curved along the discharge assistance portion 7 in the cross section along the third direction D3 further reduce the deterioration of the transient voltage protection characteristics as described above.

Between the part 5a₁ included in the edge 5a of the internal electrode 5 and the part 6a₁ included in the edge 6a of the internal electrode 6, the discharge assistance portion 7 may not include the length d1 in the second direction D2 longer than the interval d2 in the second direction D2 between the edge 7c of the discharge assistance portion 7 and the end S4 of the cavity S and the interval d3 in the second direction D2 between the edge 7d of the discharge assistance portion 7 and the end S3 of the cavity S. The transient voltage protection device 1 in which the discharge assistance portion 7 includes the length d1 longer than the interval d2 and the interval d3 further reduces the variations in the clamp voltage as described above.

What is claimed is:

1. A transient voltage protection device comprising:
an element body formed with a cavity inside;
a pair of external electrodes disposed on the element body;
a pair of internal electrodes disposed in the element body and including edges, the edges including parts opposing each other in a first direction in the cavity; and
a discharge assistance portion disposed in the element body, the discharge assistance portion being in contact with the parts included in the edges,
wherein each of the edges includes:
a first end exposed on an outer surface of the element body and connected to a corresponding external electrode of the pair of external electrodes; and
a second end located opposite the first end and including a corner,
the discharge assistance portion includes a pair of edges opposing each other in a second direction intersecting with the first direction and exposed to the cavity, and
the part included in each of the edges does not include the corner included in the second end.

2. The transient voltage protection device according to claim 1, wherein the discharge assistance portion includes another pair of edges opposing each other in the first direction and each in contact with corresponding internal electrode of the pair of internal electrodes.

3. The transient voltage protection device according to claim 1, wherein the discharge assistance portion is curved in a cross section along a third direction intersecting with the first direction and the second direction.

4. The transient voltage protection device according to claim 3, wherein the pair of internal electrodes are curved in the cross section.

5. The transient voltage protection device according to claim 4, wherein the pair of internal electrodes are curved along the discharge assistance portion in the cross section.

6. The transient voltage protection device according to claim 1, wherein, between the parts of the edges of the pair of internal electrodes, the discharge assistance portion includes a length in the second direction longer than an interval in the second direction between each of the pair of edges of the discharge assistance portion and a corresponding end of both ends of the cavity.

7. A transient voltage protection device comprising:
an element body formed with a cavity inside;
a pair of external electrodes disposed on the element body;
a pair of internal electrodes disposed in the element body, the pair of internal electrodes opposing each other in a first direction and being exposed to the cavity; and
a discharge assistance portion disposed in the element body, the discharge assistance portion being in contact with the pair of internal electrodes,
wherein each of the pair of internal electrodes includes:
a first end connected to a corresponding external electrode of the pair of external electrodes and
a second end located opposite the first end and including a corner,
the discharge assistance portion includes a pair of edges opposing each other in a second direction intersecting with the first direction,
the pair of edges are located inside the cavity when viewed in a third direction intersecting with the first direction and the second direction, and
the corner is not exposed to the cavity and is not in contact with the discharge assistance portion.
